(19) United States
(12) Patent Application Publication
(10) Pub. No.: US 2008/0295070 A1
(43) Pub. Date: Nov. 27, 2008

(54) NATIVE ACCESS TO FOREIGN CODE ENVIRONMENT

(75) Inventors: Bruno S. Bozza, Redmond, WA (US); Henricus Johannes Maria Meijer, Mercer Island, WA (US); Steven Thomas Beck, Bothell, WA (US); Jeffrey Van Gogh, Redmond, WA (US); Wei Zhu, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/752,662

(22) Filed: May 23, 2007

(51) Int. Cl. G06F 9/44

(52) U.S. Cl. 717/106; 717/114

(57) ABSTRACT

Mechanisms afford access to a foreign code environment from a native computer programming language. A program includes an attribute or declarative tag identifying foreign code associated with a native program construct. The attribute is subsequently morphed into script code that matches the calling convention and/or semantics of a related native construct.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer utilizing a programming language creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implemented code utilizing an object-oriented programming language (e.g., C#, VB, Java . . . ). In accordance with such a paradigm, programmers will create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

For the most part, programs are written in a single programming language. However, in some instances, it is desirable to interface with code outside a native code environment. Foreign function interfaces (FFIs) are employed in these situations to enable functions of a foreign language to be called from a native language. In other words, FFIs (also referred to as language bindings or native interfaces) provide a mechanism for inter-language calls such that programs written in one programming language can call routines or make use of services in specified in another programming language. Examples of conventional FFIs include platform invoke (p/invoke) and Java Native Interface (JNI) which allow source languages to specify that certain methods be implemented as native platform calls.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, systems and methods are disclosed for interfacing with a foreign code environment from a native/host programming language. More specifically, a native program can interface with existing, foreign constructs and/or functionality. In furtherance thereof, identified foreign code constructs are transformed to match native code calling conventions and/or semantics.

In accordance with one aspect of the disclosure, foreign code can be specified utilizing an attribute or declarative tag external to a related native construct. In other words, the foreign function interface is non-obtrusive. In this manner, dual mode execution can be supported, namely in native code and foreign code.

According to another aspect of the disclosure, an attribute can omit an implementation. Subsequently, the implementation can be determined and produced automatically as a function of various factors such as knowledge of one or both of native and foreign language syntax and semantics. Further yet, the generated implementation can be optimized to facilitate expeditious and efficient execution.

In accordance with yet another aspect of the disclosure, foreign code specification or identification can be statically checked to limit introduction of programming bugs. In particular, syntactic and/or semantic analysis can be performed on an attribute and included foreign code as a function of foreign language syntax and semantics as well as native construct declaration, for example.

Still another aspect of the disclosure provides for programmatic assistance to aid specification of an attribute or foreign function interface. Knowledge of native and foreign language syntax/semantics as well as associated native language construct can be employed to make suggestions, auto-fill and/or identify errors, among other things.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a computer programming system in accordance with an aspect of the claimed subject matter.

FIG. 2 is a block diagram of a representative computer program including non-obtrusive attributes.

FIG. 3 is a block diagram of a representative identifier component.

FIG. 4 is a block diagram of a representative transformation component.

FIG. 5 is a block diagram of an attribute analysis system.

FIG. 6 is a block diagram of a development assistance system.

FIG. 7 is a flow chart diagram of a method of inter-language programming.

FIG. 8 is a flow chart diagram of a method of interacting with code that interfaces with foreign language code.

FIG. 9 is a flow chart diagram of a method of attribute analysis.

FIG. 10 is a flow chart diagram of a method of foreign code transformation.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods are provided hereinafter with respect to interaction amongst a native/host programming language and foreign/guest language. The host language can include a non-obtrusive attribute associated with a native programmatic construct that identifies information pertaining to a foreign code implementation of the construct. The attribute can be employed to translate and/or generate foreign code matching host language calling conventions and/or semantics. In one instance, the program can be considered to have dual modes such that a construct can be executed in the host language and/or a guest language. Further yet, code associated with the attribute can be analyzed to identify errors and intelligent feedback provided to facilitate specification of the attribute and code therein.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

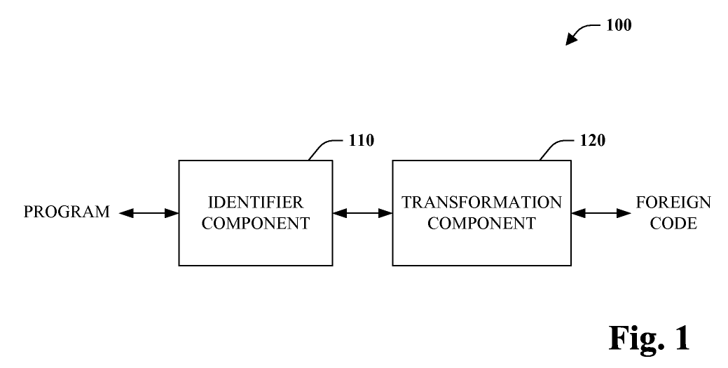

Referring initially to FIG. 1, a programming system 100 is illustrated in accordance with an aspect of the claimed subject matter. The system 100 facilitates interaction with a foreign/guest programming language from a native/host programming language. Identifier component 110 is a mechanism that identifies foreign code or an indication that foreign code should be employed for a particular portion of a program. In one instance, the identifier component 110 can scan a program for a particular keyword, token or other syntax identifying such code. Transformation component 120 can receive, retrieve or otherwise obtain or acquire code identified by the identifier component 110. Subsequently or concurrently, the transformation component 120 can transform or morph the identified code into a version that matches host language calling conventions and/or semantics.

In accordance with one aspect, programming system 100 can correspond to a foreign function interface for browser script languages. Conventional FFIs such as platform invoke allows source languages to specify that certain methods be implemented as native platform calls, but platform invoke is limited to global methods. This is adequate when that native platform includes libraries (e.g., dynamically linked libraries (DLLs)) that expose global functions. However, where the source language is object-oriented and the underlying platform is also object-oriented, the system 100 can perform object-to-object mappings to take advantage of the platform.

One exemplary use case can be for compiling code to browser script. For instance, a source code program can be developed (e.g., C, C#, VB, Java . . . ) and compiled to an intermediate language (e.g., common intermediate language). Subsequently, the intermediate language code can be compiled or translated to browser script code. In this case, situations can exist where programmers wish to designate interaction with existing or native browser script code. Programmers can specify or otherwise identify such interactions in a specific host programming language. However, the host language and guest, browser script language can be quite different. For example, the host language can include much richer constructs (e.g., properties, events, delegates, constructors . . . ) than the guest language (e.g., functions). The system 100 can bridge such gaps by morphing browser script calling conventions and/or semantics to those of the host language. For instance, the system 100 can facilitate access to a host language property in C# or IL via a JavaScript function.

It is to be noted that the system 100 provides several advantages over other approaches. In particular, conventional foreign function interface systems provide an un-interpreted translation, wherein users are required to specify all foreign functionality explicitly and it is blindly translated. Here as will be described further infra, users are not required to specify everything explicitly thereby facilitating development. Moreover, the calling conventions and/or semantics of a host language and guest language are known such that intelligent decisions can be made to automatically match or bridge the two worlds.

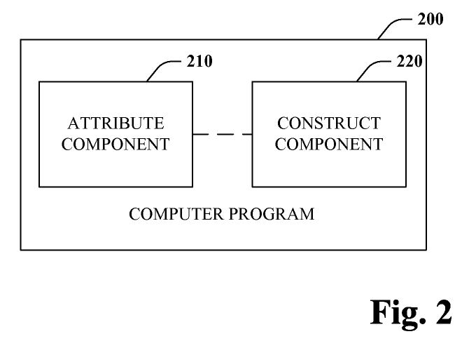

Turning to FIG. 2, a representative program 200 is illustrated in accordance with an aspect of the claimed subject matter. The program 200 can be of any programming language (e.g., C, C#, VB, Java . . . ). However, in accordance with one aspect, the program can be of a common intermediate language (CIL) wherein multiple programming languages compile to a single intermediate language (IL). The program 200 includes an attribute component 210 and a construct component 220. The attribute component 210 can be a program language custom attribute or declarative tag that specifies that foreign browser script code should be employed with respect to a particular language construct 220 (e.g., class, method, constructor, event . . . ). In one instance, the attribute component 210 can specify a complete browser script implementation. However, this is not necessary as the code can be generated automatically as a function of provided and/or contextual information. For example, the attribute component 210 can be specified in a high level programming language as “[BSImport(Function=“alert”)]” indicating that browser script (BS) code is being imported into a source language and that the foreign script function “alert” should be invoked in connection with an associated construct component 220. In another instance, the attribute component can be “[BSImport(Property=“value”)]” denoting that browser script should assign data passed to this property to the browser script property named “value.” It is also to be appreciated that the attribute component 210 can include or support a number of additional parameters that control how the attribute is interpreted and/or transformed, among other things.

In accordance with one aspect, the program 200 can be executable in two different or dual modes. By way of example and not limitation, where the program code corresponds to IL the program can be run like any other IL program utilizing a particular virtual machine or runtime for execution. This facilitates testing and development processes, inter alia. Additionally, the program 200 can be executable as a browser script. Accordingly, the attribute component 210 can specify or initiate generation of guest, browser script code separate from a host language implementation. As a result, the attribute component 210 may need to be specified outside the corresponding construct component 220 in a non-obtrusive manner to enable dual mode execution to be supported.

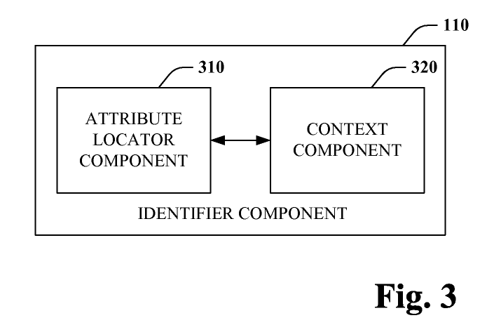

A representative identifier component 110 is depicted in FIG. 3, in accordance with an aspect of the claimed subject matter. As previously described, the identifier component 110 is a mechanism for identifying and provisioning foreign/guest, browser script code for transformation. More specifically, the identifier component 110 can include an attribute locator component 310 and a context component 310. The attribute locator component 310 can locate browser script segments of a host program. These segments can be represented or delineated in a program in a plurality of manners, for example via keywords, tokens or other distinguishing syntax. For example, the locator component 310 can identify script segments denoted with brackets and a keyword “BSImport” or the like.

The context component 320 can cooperate with the attribute locator component 310 and identify a programmatic context associated with a browser script segment. This is significant since browser script code can be generated and/or translated as a function of programmatic context, as will be described further infra. In one instance, context can be identified by the context component 320 by discovering a programmatic element or construct with which an attribute is associated and determining or inferring its functionality, among other things. By way of example and not limitation, context can correspond to types of members such as methods, properties, indexers, events and/or sub-categories thereof.

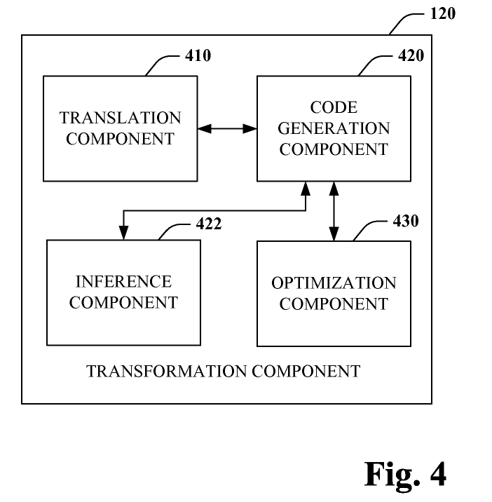

Referring to FIG. 4, a block diagram of a representative transformation component 120 is illustrated in accordance with an aspect of the claimed subject matter. As provided previously, the transformation component 120 is a mechanism for transforming or morphing script attribute information and/or code to simulate/match host language calling conventions and/or semantics. Translation component 410 is operable to translate browser code, declarations or portions thereof to browser code that simulates host language features.

The translation component 410 can interact with code generation component 420 to assist in translation. Script attributes need not be specified completely where the missing information is capable of being inferred. In these cases, the code generation component 420, alone or in conjunction with an internal or external inference component 422, can generate missing code. For example, a script attribute can be attached to method, property and/or event declarations omitting the implementation. During transformation, besides translating the declaration, the body of a method can be filled with browser script access code. In another case, where an existing foreign function is not explicitly identified by an attribute, the inference component 422 can infer the name of the function based on an associated construct function name and/or other information concerning native and foreign languages, and the function name can be inserted by the code generation component 420. In this and other manners, intelligent decisions can be made regarding how to bridge native and foreign code worlds.

The transformation component 120 further includes an optimization component 430 communicatively coupled to the code generation component 420. The optimization component 430 can include a number of mechanisms to optimize code generation as a function of the code alone or in conjunction with other context information, for example. As a result, generated code is optimized for execution based or predetermined rules or inferences that can be made about logic and/or resources employed.

What follows is a description of various exemplary scenarios to facilitate clarity and understanding with respect to various aspects of the claimed subject matter. The examples are described with respect to transforming an intermediate language code previously specified in C# to JavaScript. It is to be appreciated that the claimed subject matter is not to be limited to specifies provided with respect to the below examples. There are numerous other ways that claimed aspects can be practiced or employed all of which are to be deemed within the scope of the appended claims. Examples are now provided for transformation of static methods, instance methods, properties, constructors and events.

Browser script attributes and/or code can be associated with static methods. Static methods act at a class level rather than an instance level. Hence, a static method should not refer to a specific instance of a class. Static methods can be translated to JavaScript functions whose parameters (if any) are exactly those of the declared methods and whose implementation simply calls a user specified JavaScript function passing those parameters. Consider for example:

```
class Document
{
    [JSImport(Function = “alert”)]
    extern static public void Alert(string message);
}
```

Here, the class “Document” includes a static method “Alert” with a single parameter “message” and a custom attribute delineated by square brackets (“[ . . . ]”) specifying that a JavaScript function “alert” should be called for a browser script implementation. This high-level code can be compiled by a standard language compiler to the following intermediate code:

```
.method public hidebysig static void Alert(string message) cil managed
{
    .custom instance void
    [XxxCorLib]Xxx.JSImportAttribute::.ctor( ) = ( 01 00
    01 00 53 0E 08 46 75 6E 63 74 69 6F 6E 05 61 6C 65 72 74 )
}
```

In turn, the intermediate language code can be transformed utilizing aspects of the claimed subject matter to the following JavaScript function:

function Document$Alert$System$String$($a0)
{
return alert($a0);
}

Here, the JavaScript function “Document$Alert$System$String$($a0)” is produced corresponding to the host language static method “Alert.” As specified by the attribute, the native “alert” function is called with a single parameter “$a0.” Further, In JavaScript, “void” functions or those without a return statement actually return “null” at runtime. Accordingly, transformations of native calls can be preceded with the keyword “return,” regardless of whether the call returns something that is meaningful.

In this example, the function name “alert” was explicitly provided by a user via the script attribute. However, this name is not strictly required. In accordance with an aspect of the claimed subject matter, the name can be omitted and subsequently inferred and generated as a function of the high-level language name “Alert” and/or knowledge of script functions, among other things.

It is to be noted that the preceding example identified the generated intermediate code associated with compilation of a high-level program. However, for purposes of further clarity and brevity, the remaining examples are presented without the intermediate code with an understanding that it can be an intermediate step.

Instance methods refer to specific instances of class and as such are slightly more complicated than static methods. In particular, a pointer to the instance (e.g., “this”) is implicit in some host languages. To match the implied calling convention of such a host language to JavaScript, an implicit instance reference can be made explicit. By way of example, consider the following code snippet and associated transformation:

```
class DomElement
{
    [JSImport(Function = “appendChild”)]
    extern public void AppendChild(DomElement el);
}
function DomElement$AppendChild$DomElement$($a0, $a1)
{
    return $a0.appendChild($a1);
}
```

In this case, a method “Append Child” is called on a DOM (Document Object Model) object. The attribute specifies that the “appendChild” native JavaScript function should be utilized. In the transformation, the JavaScript function includes an additional parameter representing the object on which the method is being called “$a0,” wherein “$a1” represents the original method parameter.

Here, the translated function utilizes dot notation—object dot(“.”) method. As an alternative, the translated function could simply provide the object as the first parameter, namely “append.Child($a0, $a1)” rather than in a dot notation. In one instance, this could be controlled by addition attribute parameter flag that distinguishes between a dot notation and first parameter transformation.

Static and instance properties can simply correspond to specially named methods. Accordingly, a similar mechanism can be employed to generate property signatures as was utilized for static and instance methods. However, it may be desirable for the implementation to access a JavaScript property or object field. In that case, the attribute can include a set “Property” field. By way of example consider the following code segment:

```
class InputElement : DomElement
{
    extern public string Value
    {
        [JSImport(Property = “value”)]
        get;
        [JSImport(Property = “value”)]
        set;
    }
}
```

Both the “get” and “set” methods are provided here, but either alone would suffice. For the above input, the following can be generated:

```
function InputElement$get_Value($a0)
{
    return $a0.value;
}
function InputElement$set_Value$System$String$($a0, $a1)
{
    $a0.value = $a1;
}
```

Note that the logic associated with getting a value and setting a value is omitted in the attribute and automatically provided or encapsulated in the generated code.

The next example deals with constructors, which are programmatic elements that construct an object or class instance. Constructors require special care in both semantics and implementation such that objects constructed in the scripting language include features of host language objects. For example, a host language may support virtual methods on objects. More specifically, to support virtual methods and polymorphism objects can have a virtual table or v-table. Accordingly, when generating objects one or more mechanisms should be provided to equip externally created objects with the same features as internally created objects of a host language.

In one implementation, constructors decorated with a particular keyword (“BSImport”) can employ an object returned by a JavaScript function call as an instance or “this” reference for the lifetime of the object. This feature is particularly useful and unusual in programming language native interfaces. It allows developers to utilize code such as the following:

```
class DomElement
{
    [JSImport(Function = “document.createElement”)]
    extern public DomElement(string tag);
}
class InputElement : DomElement
{
    public InputElement( ) : base(“input”){ }
    extern public string Value
    {
        [JSImport(Property = “value”)]
        get;
    }
}
```

Furthermore, it is to be appreciated that a mechanism can be employed to correctly attach type information to a return value of a generated method.

Events can also require some extensive tranformation where the concept of an event is different in a host and guest language. Events are simply instances where something has occurred, such as mouse click. Most languages include a high-level concept of events where an object can expose signals and other objects can subscribe to and react to such signals. However, implementations can be different amongst a host and guest script language such that a direct mapping does not preserve host language semantics. For example, a host language can support registration of multiple handlers for a single event (e.g., via multicast delegates), whereas a guest language like JavaScript can support only a single handler per event. In a case of a button, the host language can support a list of actions, while JavaScript supports a single action, upon click detection. Accordingly, a host language multicast approach may need to be mapped or implemented on top of a single cast events of a guest language.

By way of example, consider the following code fragment:

```
class Button : InputElement
{
    [JSImport(Property = “onclick”)]
    extern public event DomEvent Click;
}
```

The developer interface, as expected by now, consists of adding a “JSImport” attribute and specifying a JavaScript event to which to bind. Because events in JavaScript are simply properties, the “Property” field of the attribute can be used. The above code can be transformed to the following script code leveraging the fact that JavaScript allows overriding of function pointers:

```
function Button$add_Click$DomEvent$($a0, $a1)
{
    $a0.Button$Click =
System$Delegate$Combine$System$Delegate$System$Delegate$($a0.-
Button$Click, $a1);
    if (!$a0.onclick) {
        $a0.onclick = function( ) { return
DomEvent$Invoke($a0.Button$Click); };
    }
}
function Button$remove_Click$DomEvent$($a0, $a1)
{
    $a0.Button$Click =
System$Delegate$Remove$System$Delegate$System$Delegate$($a0.-
Button$Click, $a1);
    if (!$a0.Button$Click) {
        $a0.onclick = null;
    }
}
```

### JavaScript Functions

“System$Delegate$Combine$System$Delegate$System$Delegate$” and “System$Delegate$Remove$System$Delegate$System$Delegate$” are part of a multicast delegate implementation. They return delegates that contain the concatenation and difference between two delegate invocation lists, respectively. For instance, the first time a delegate is assigned to an event a function is created and the event is assigned to a function that involves the delegate. The delegate can then go through the handler list and dispatach events to each handler. Notice that because multicast delegates handle invocation lists internally, the delegate type's “Invoke” method need only be called once. In addition, because the translation generates “pure” JavaScript, independent of browser object model, any browser differences can be avoided at the compiler level.

It is to be noted that the claimed subject matter is not limited to class members such as functions and methods. The disclosed innovated aspects are also applicable to other programmatic constructs or elements such as objects or classes themselves. Accordingly, an attribute or declarative tag can be present on a class or type to facilitate transformation of a guest language object or intrinsic type (e.g., string, number, date/time, regular expressions . . . ) to a host language version thereof. Where the guest language is JavaScript or like scripting language, a prototype mechanism can be employed to set extra fields in an object that can be created. For example, a “string.prototype=myfunction( . . . )” assigns a new function to the intrinsic type string.

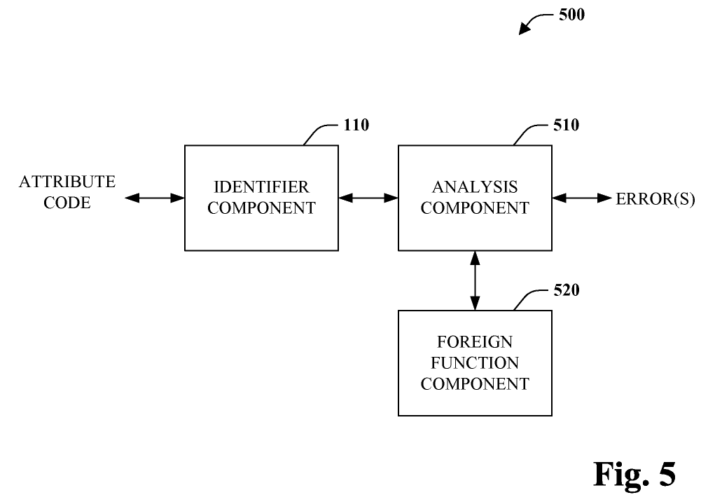

Turning attention to FIG. 5, an attribute analysis system 500 is illustrated in accordance with an aspect of the claimed subject matter. The system 500 includes the identifier component 110 an analysis component 510 and a foreign function component 520. As previously described, the identifier component 110 can be employed to identify a particular attribute such, as a script attribute, within a program, for example a function of a particular syntax. An identified attribute can be analyzed by the analysis component 510 in view of information received or retrieved from the foreign function component 520. The foreign function component 520 can include information concerning functions, methods or the like sought to be imported into a host program language via an attribute. In other words, the foreign function component 520 can be a library of information pertaining to such imported language such as a browser scripting language. The analysis component 510 can utilize this information to determine if an attribute and/or code specified therein is correct. If not, an error can be produced indicating that the code is incorrect and optionally identifying the problem and posing solutions thereto.

It should further be appreciated that the analysis component 510 can also consider attribute context information provided by the identifier component 110, for example, to facilitate checking shorthand code. As previously described, attribute requirements can be allowed to vary where required information can be inferred from context. Accordingly, the analysis component 510 can include inference mechanisms or components such that errors can be generated where required information cannot be determined.

Historically conventional foreign function interface systems have been a source of bugs and runtime errors since compilers treat such information as opaque strings. The system 100 can prevent these errors by performing static checking. More specifically, attribute code can be analyzed syntactically and/or semantically to determine if the right number of arguments are provided and/or that the function being hooked into is correct, among other things. This is valuable in preventing runtime errors from occurring. However, there can be situations where a user may want an attribute and/or code therein treated as an opaque string. In such a scenario, the attribute can indicate via a parameter or other mechanism that code analysis should be turned off.

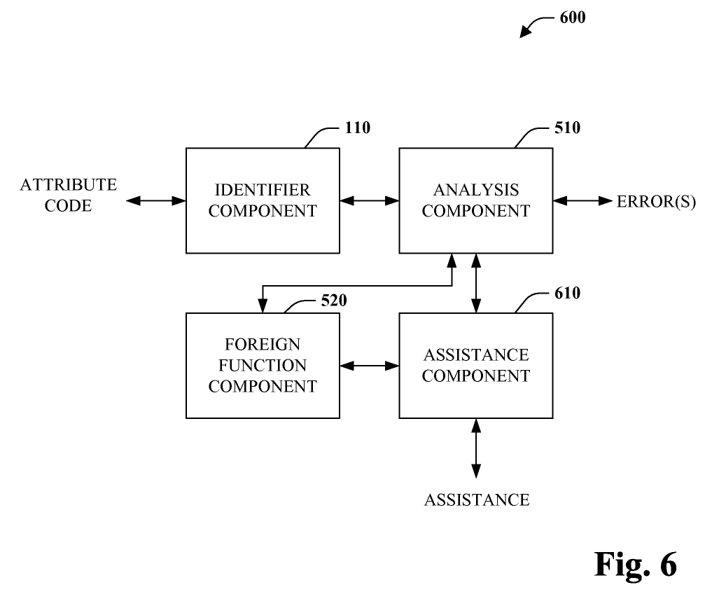

FIG. 6 illustrates a development assistance system 600 in accordance with an aspect of the claimed subject matter. Similar to system 500 of FIG. 5, system 600 can include the identification component 110, analysis component 510 and foreign function component 520, as previously described. In brief, the system 500 is operable to analyze attributes and/or code associated therewith in light of foreign function information and/or context information to facilitate identification of programmatic errors prior to execution. System 600 extends system 500 with an assistance component 610 communicatively coupled directly or indirectly to the analysis component 510 and/or the foreign function component 530. The assistance component 610 can employ these and other components to aid users in specification of attributes. In particular, the assistance component 610 can supply feedback to users as an attribute is written. For example, suggestions can be presented in a drop-down menu for selection or portions of code auto filled based on specification of at least a portion of an attribute as well as other context information including the programmatic element associated with the attribute and foreign function information. In one instance, an attribute function name can be suggested based on an associated method declaration. Additionally or alternatively, the assistance component 610 can interact with the analysis component 510 as code is received or specified to identify errors or potential for errors in specified program code. This information can also be utilized with respect to affording relevant/correct assistance.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, transformation component 120 can employ such mechanisms to facilitate translation and/or generation of foreign language code (e.g., browser script) matching calling convention and/or semantics of a host language code (e.g., IL, CIL . . . ).

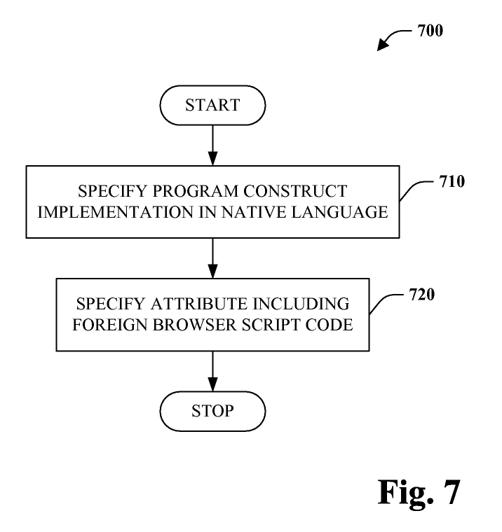

In view of the exemplary systems described sura, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a programming method 700 is illustrated in accordance with an aspect of the disclosed subject matter. At reference numeral 710, a programmatic construct or element declaration and implementation are specified in a host language. At numeral 720, an attribute or declarative tag is specified including or referencing foreign code such as browser script code. The attribute can be specified in connection with a particular programmatic construct implementation. Furthermore, the attribute can be specified outside an associated construct to enable dual mode execution where desired. Still further yet, the attribute need not include a complete implementation of the construct in the foreign or guest programming language. Syntactically, the attribute can be represented in any number of distinguishing manners. In one instance, it can be represented with brackets and a keyword among other things such as in “[BSImport( Function=“alert”)].” It is also to be appreciated that the attribute can include any number of parameters or parameter flags for customizing use or transformation thereof. By way of example and not limitation, the parameters can indicate whether or not code is to be analyzed for errors or treated as a string. Similarly, an attribute parameter may be utilized to specify whether a dot notation or argument notation is to be utilized with respect to instance methods.

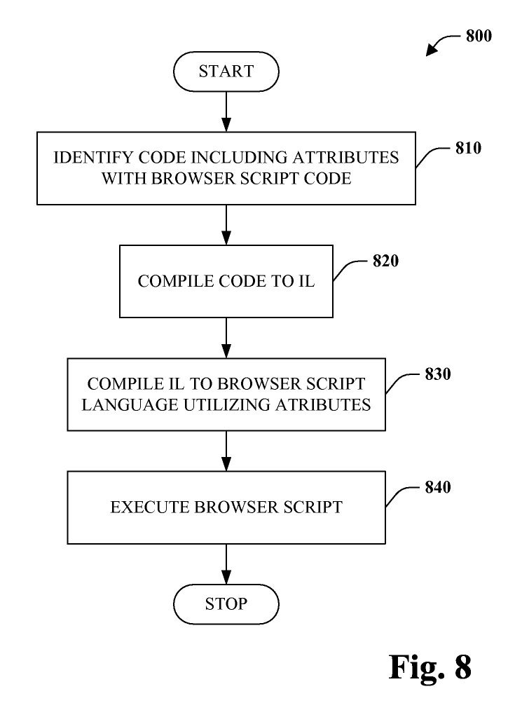

FIG. 8 illustrates a method 800 of interacting with code including a foreign function interface. At reference numeral 810, programmatic code is identified that includes attributes associated with browser script code and/or other disclosed aspects. This code can be written in a high-level programming language such as C#, C, C++, VB or Java to name but a few. At numeral 820, the code is compiled to an intermediate language (IL). In one instance, the IL can correspond to a common intermediate language (CIL), a single intermediate language to which multiple languages compile and can subsequently be run. In accordance with one aspect, the IL code can be executed via an associated execution engine or runtime to facilitate testing and development, among other things. The IL code can then be compiled or otherwise transformed and/or translated to a browser script language utilizing the attributes at 830. At reference numeral 840, the browser script code is executed in a browser.

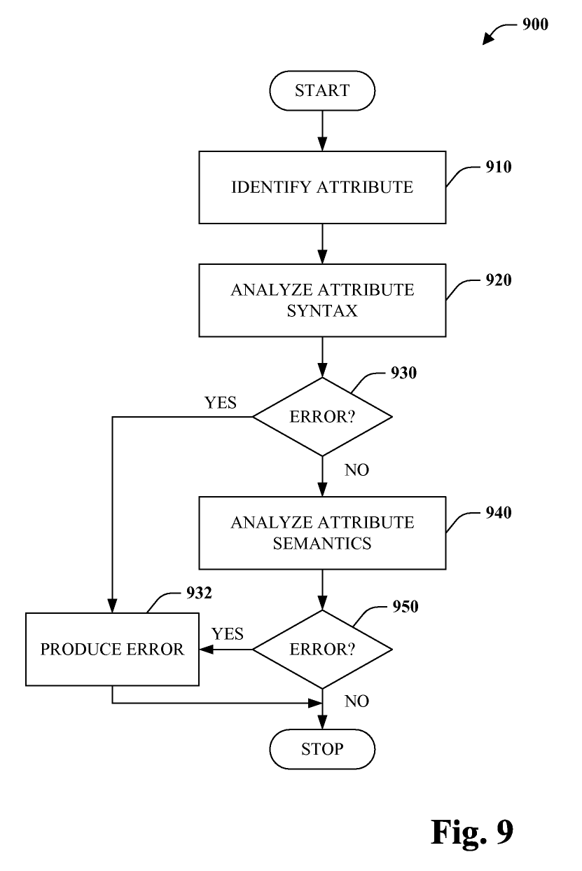

Referring to FIG. 9, a method of code analysis 900 is depicted in accordance with an aspect of the claimed subject matter. Conventionally, foreign function calls are treated as opaque, un-interpreted strings. However, the inventors note that this can be the source of programming bugs that may result in runtime errors and/or program crashes. Accordingly, method 900 is introduced. At reference numeral 910, an attribute identifying a foreign function, method or the like is identified. In accordance with one aspect, the attribute can correspond to browser script code within host IL code. At numeral 920, attribute syntax is analyzed and a determination is made at 930 as to whether a syntactic error exists. If an error exists, an error is produced at numeral 932 and the method 900 terminates. If no syntactic errors exist, then attribute semantics are analyzed at 940. Among other things, attribute analysis can be performed with respect to knowledge of an associated host language construct and/or guest language semantics. At numeral 950, a determination is made as to whether a semantic error is present. If yes, the method 900 produces an error at numeral 932 and terminates. Otherwise, the method 900 simply terminates without production of an error.

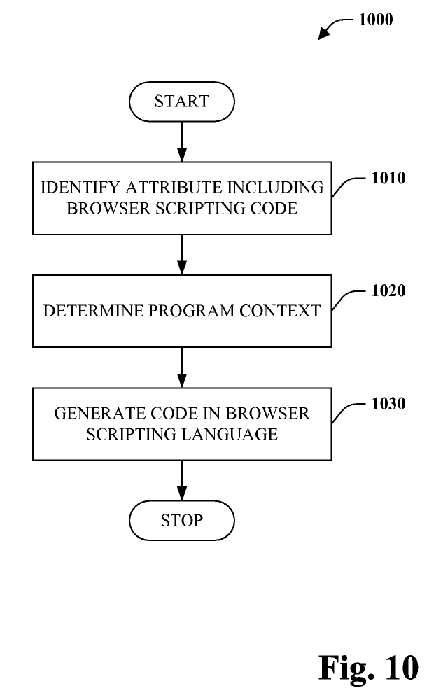

FIG. 10 is a flow chart diagram of a method 1000 of transforming foreign code in accordance with an aspect of the claimed subject matter. At reference numeral 1010, an attribute is identified including or referencing browser script code, for example. The attribute can be identified by one or more of various distinguishing syntax, keywords, tokens or the like. In one instance, an attribute can be specified with square brackets and a keyword such as “[BSImport( . . . )],” although specification is not limited thereto. At numeral 1020, program context can be determined. This can correspond to determining a programmatic construct associated with an identified attribute, for instance. For example, the context can identify that the attribute is associated with a static method, an instance method, a constructor or an event, among other things. At reference numeral 1030, the attribute alone or in conjunction with context information is employed to generate code in a foreign browser script language, for example. Code generation can correspond to a simple translation from one calling convention to another and/or injection of code to match host code semantics, among other things. In one particular instance, code generation can comprise identifying and or generating a foreign function name as a function of an associated construct declaration.

It is to be appreciated that the subject systems, methods and the like are not limited to browser script code. They are appropriate or applicable for interfacing with any foreign code. The specific references to browser script or more specific JavaScript® are merely one particular implementation utilized to clarify and simply explanation of more broadly applicable concepts.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

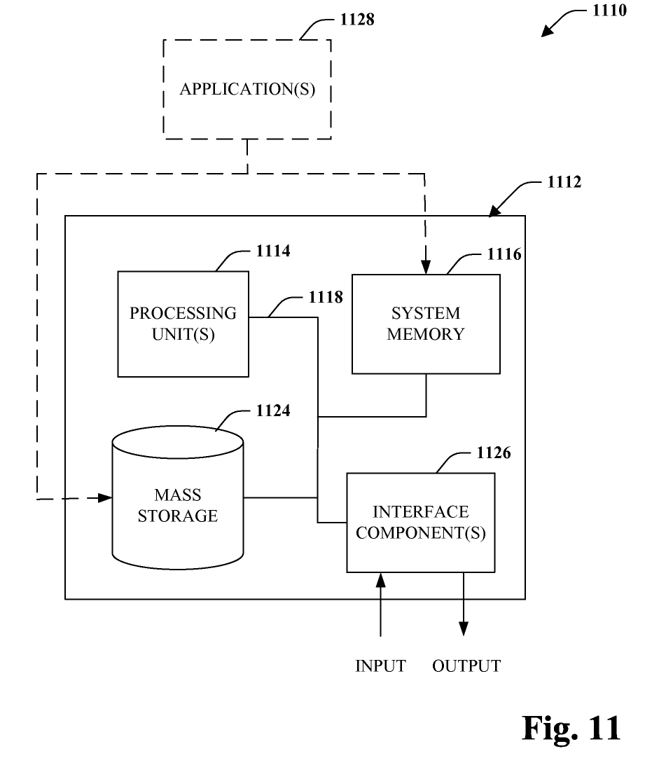

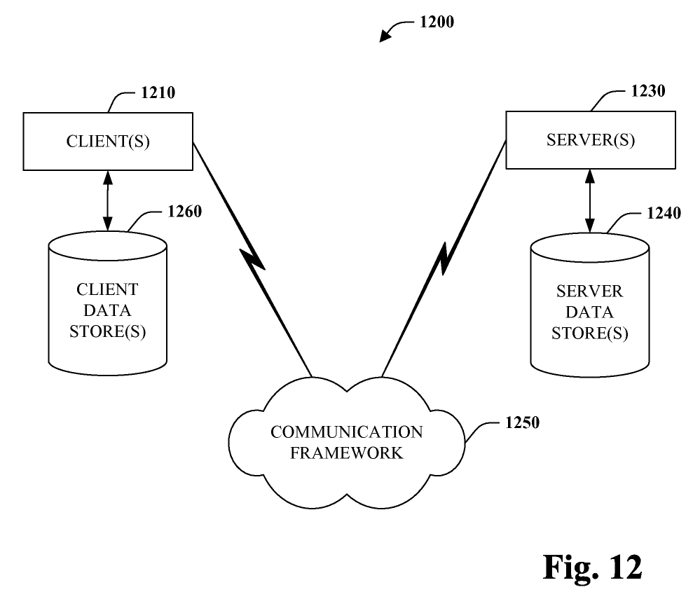

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116 and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

By way of example and not limitation, code including script attributes can be developed, compiled into intermediate language code and transformed to browser script on either or both of client(s) 1210 and server(s)1230. Subsequently, browser script can be distributed by server(s) 1230 to client(s) 1210 via the communication framework 1250 for execution by associated browsers. In accordance with one aspect, this can enable new applications to be developed utilizing powerful programming languages (e.g., C#, Java, VB . . . ) and transformed into browser executable code to afford computer platform independence, among other things.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A computer programming system, comprising:
an identifier component that identifies an attribute in a native language program that specifies foreign code associated with a native construct; and
a transformation component that transforms the code to match native code calling conventions.

2. The system of claim 1, the attribute is specified external to the native construct.

3. The system of claim 2, the native construct includes an implementation in the native language.

4. The system of claim 2, the native construct is one of a class, method, property, constructor and event.

5. The system of claim 1, further comprises a code generation component that generates foreign code that matches native construct semantics.

6. The system of claim 5, further comprising a component that optimizes the generated code for execution.

7. The system of claim 1, further comprising a component that determines a function name from the native language construct.

8. The system of claim 1, further comprising an analysis component that analyzes the code for syntactic and/or semantic errors.

9. The system of claim 1, the native language program is an intermediate language program.

10. The system of claim 1, the foreign code is browser script code.

11. A method of program compilation, comprising:
acquiring an intermediate language program including an attribute associated with a member that identifies foreign code; and
transforming the code to match intermediate language calling conventions and member semantics.

12. The method of claim 11, further comprising performing syntactic and/or semantic checking of the code for errors.

13. The method of claim 11, transforming a static method to a script function.

14. The method of claim 11, transforming an instance method to a script function including an additional parameter as a pointer to an object instance on which the method is called.

15. The method of claim 11, transforming a property or specially named method to a script function.

16. The method of claim 11, transforming an object constructor to a script function that attaches type information to a return value of a generated method.

17. The method of claim 11, transforming an event to one or more script functions that enable multiple handlers to be implemented on top of single handler script events.

18. A computer-readable medium having stored thereon a computer program, comprising:
a representation of a class including a member thereof, and
a representation of a declarative tag external to the member that specifies a browser script function and/or property to facilitate implementation of the member in a browser script environment.

19. The computer-readable medium of claim 18, the class and declarative tag are represented in a common intermediate language.

20. The computer-readable-medium of claim 18, the member is one of a method, a property, a constructor and an event.
